(19) United States
(12) Patent Application Publication
(10) Pub. No.: US 2024/0403874 A1
(43) Pub. Date: Dec. 5, 2024

(54) Systems and methods for fractionalizing a collectible into blockchain tokens

(71) Applicant: Fraction Motors, LLC, Germantown, TN (US)

(72) Inventor: JASON M. FISHER, GERMANTOWN, TN (US)

(73) Assignee: Fraction Motors, LLC, Germantown, TN (US)

(21) Appl. No.: 18/429,287

(22) Filed: Jan. 31, 2024

Related U.S. Application Data
(60) Provisional application No. 63/482,767, filed on Feb. 1, 2023.

(51) Int. Cl. G06Q 20/38; G06Q 30/02

(52) U.S. Cl. CPC G06Q 20/389; G06Q 20/3825; G06Q 30/0278

(57) ABSTRACT

An online blockchain platform that allows users to sell and purchase tokens stored on the blockchain that are associated with a particular collectible. These tokens reflect 100 percent ownership of the collectible and entitle the holders to certain rights relating to the collectible including a percentage of any future sale or insurance proceeds of the collectible. The tokens include descriptions and attributes of the collectible, media files including digital images and videos, insurance documents, and appraisal documents. Storage on the blockchain provides a shared, immutable ledger that facilitates the process of recording transactions and tracking assets in a decentralized network.

### CROSS REFERENCE TO RELATED APPLICATIONS

This application claims priority to and incorporates by reference the following applications: U.S. Provisional Patent Application 63/482,767 filed Feb. 1, 2023, which is pending.

### FIELD OF THE INVENTION

The present invention relates to administration of collectibles, and more particularly to systems and methods for fractionalizing collectibles into blockchain tokens and for sale of tokens.

### BACKGROUND OF THE INVENTION

Collectibles can be defined as works of art, antiques, comics, textiles, stamps, coins, jewelry, weapons, cars, planes, motorcycles, toys, as well as any other goods or items that have value to collectors.

Prior to this invention, people either acquired and owned these collectibles personally or through a business entity, such as a corporation. If owned by a company, the company could sell shares to individuals, in which case the company was responsible for keeping the collectible safe, maintained, and insured. These costs plus the operating costs of the company were passed to the shareholders. Having a company involved created a conflict of interest between the fractional owners and the company that wanted to be profitable, which meant they had to charge even more than the operating costs.

Often, private collectors acquire their collections over a lifetime and become sentimental about their collections. They enjoy owning the collectibles and displaying them in their homes, galleries, garages, and hangars. The costs to maintain and insure these collections are already being borne by the collector. Additionally, when an asset owner sells an asset, there is often an auction fee or a sales agent fee, such as twenty percent of the sales price.

Often, private collections are converted to museums to keep a collection together and provide a tax deduction to the collector. The museum offsets the costs of maintaining and insuring the collection by charging admission fees but rarely do these fees offset all of the costs.

Unrestored originals and restored collectibles have been a staple of many people's collections. However, nowadays many people do not have the money, space, or resources to buy, hold or restore these historic collectibles. On top of this, these original and restored collectibles have gone up in value over time. The owners of these collectibles may not wish to get rid of their collectibles but would like to make additional revenue off of their assets while still maintaining physical ownership.

### OBJECTS AND SUMMARY OF THE INVENTION

It is an object of the invention to provide a digital platform to allow collectors (buyers) the opportunity to own physical assets that they otherwise could not afford or obtain.

It is an object of the invention to provide a digital platform on which collectible owners (sellers) can place their collectibles to make additional capital through the process of fractionalizing ownership.

It is an object of the invention to provide a digital platform that allows viewers to become more educated on the price, rarity, and history of historic collectibles from across the globe.

It is an object of the invention to provide a way for the token collectors to make additional revenue through the appraisals of the collectibles.

It is an object of the invention to provide yet another way for the token collectors to make additional revenue by selling the tokens on the company's secondary market.

The foregoing objectives are achieved by providing systems and methods having the features described herein.

In embodiments, a method of administering an online blockchain platform is provided that allows users to purchase and sell tokens stored on a blockchain that are associated with a particular collectible asset, said blockchain providing a shared, immutable ledger that facilitates the process of recording transactions and tracking tokens of collectable assets in a decentralized network. The method comprises providing a processing program for fractionalizing an asset into tokens and for enabling a market for purchase and sale of the tokens, the processing program providing a visual interface for use by a plurality of buyers and sellers for offering to sell and purchase tokens representing fractions of assets; providing at least one collectable asset for fractionalizing into tokens using the processing program, the at least one collectable asset owned by an asset owner; and registering the at least one collectable asset with the processing program. Registering includes fractionizing a plurality of blockchain tokens reflecting one hundred percent ownership of the collectible asset, the tokens entitling holders of the tokens to rights in a future disposition of the collectible asset, including a proportionate percentage of any future sale or insurance proceeds of the collectible asset.

In embodiments, providing at least one asset for fractionalizing into tokens comprises: the asset owner proving title to the asset; the asset owner providing an appraisal of the asset, the asset obtained from an appraiser; and the asset owner providing proof of insurance on the asset up to at least the value of the appraisal. In embodiments, the appraiser is a licensed appraiser.

In embodiments, the methods further comprise using the processing program to enable users of the processing program to purchase tokens of the at least one collectable asset from the asset owner in an initial offering and thereby become holders of the tokens, the processing program associating purchased tokens with blockchain wallets of each holder of a token. In embodiments, the methods further comprise using the processing program to enable holders of tokens of the at least one collectable asset to offer to sell and to sell tokens to subsequent holders of tokens in a secondary market, the processing program associating purchased tokens with blockchain wallets of each subsequent holder of a token.

In embodiments, registering a collectable asset further includes using a Register a New Asset page for recording an Asset Owner Public Key comprising a public blockchain key or wallet address of the asset owner; recording an Asset Type identifying the type of asset, recording a Blockchain Network on which the tokens will be created, generating a Symbol that uniquely identifies the collectible asset, and assigning a Total Fractions figure consisting of the number of tokens for the collectable asset.

In embodiments, registering a collectable asset further includes using the Register a New Asset page for recording a Vehicle Identification Number. In embodiments, registering a collectable asset further includes using the Register a New Asset page for recording an appraised price of the collectable asset. In embodiments, registering a collectable asset further includes using the Register a New Asset page for recording a description of the collectable asset. In embodiments, registering a collectable asset further includes using the Register a New Asset page to associate media documentation with the assets, such as photos, appraisal documents, and insurance documents. In embodiments, a default value for the Total Fractions is 100,000.

In embodiments, each asset owner maintains possession of their respective collectable asset and is responsible for maintaining the condition of the asset.

In embodiments, an owner or licensed administrator of the processing system collects a royalty from an asset owner for registering an asset with the processing program. In embodiments, an owner or licensed administrator of the processing system collects a transaction fee from buyers upon purchase of tokens. In embodiments, an owner or licensed administrator of the processing system collects a transaction fee from sellers upon sale of tokens.

In embodiments, the at least one asset is a motor vehicle. In embodiments, the motor vehicle is an automobile, a truck, a boat or a motorcycle.

The foregoing and other objects, features, aspects and advantages of the invention will become more apparent from the following detailed description of the invention when considered in conjunction with the accompanying drawings.

### BRIEF DESCRIPTION OF THE DRAWINGS

FIG. 1 is an embodiment of an inventory page of available collectibles for use in the system and methods of the invention.

FIG. 2 is an embodiment of an initial buy page for use in the systems and methods of the invention.

FIG. 3 is an embodiment of a secondary market page for use in the systems and methods of the invention.

FIG. 4 is an embodiment of a wallet page for use in the systems and methods of the invention.

FIG. 5 is an embodiment of an initial buy page for tokens for a collectable for use in the systems and methods of the invention.

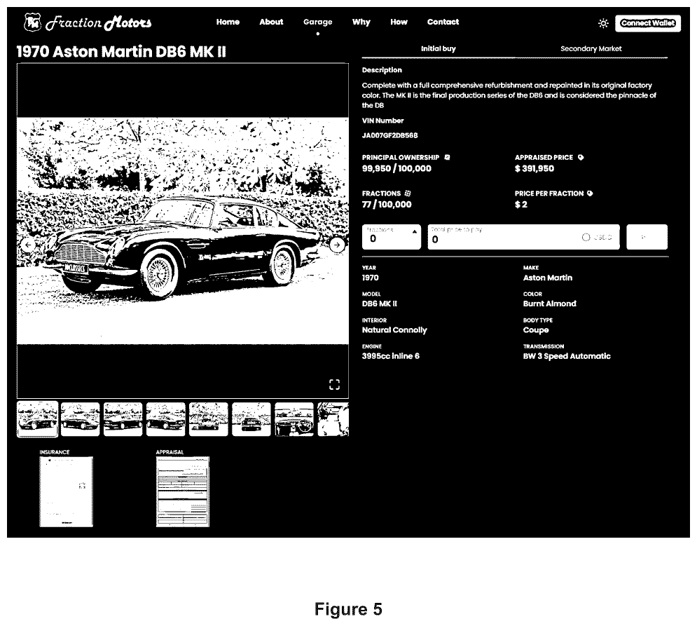

FIG. 6 is an embodiment of a secondary market page for tokens for a collectible for use in the systems and methods of the invention.

FIG. 7 is a flow chart of embodiments of the systems and methods of the invention for fractionalizing tokens.

FIG. 8 is an embodiment of a page for registering a new asset for use in systems and methods of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

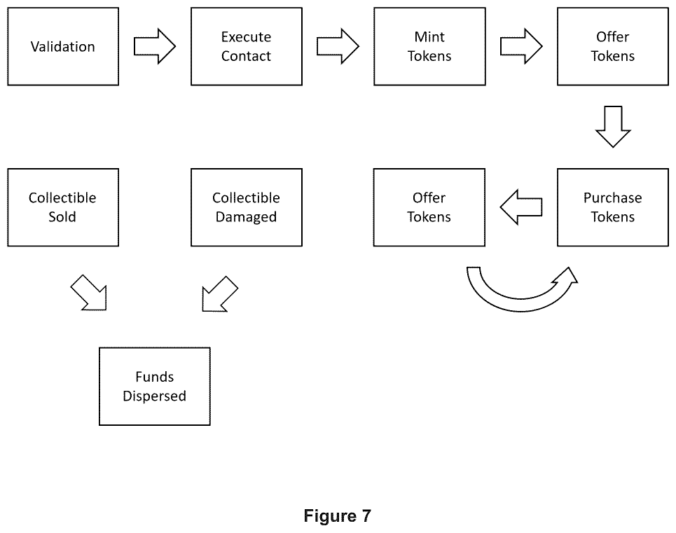

The foregoing and other objectives are achieved by providing systems and methods for fractionalizing a collectible into blockchain tokens and a means for buyers and sellers to trade those tokens, as outlined in the flow chart of FIG. 7. These tokens reflect 100% ownership of the collectible and entitle the holders to certain rights relating to the collectible including a percentage of any future sale or insurance proceeds of the collectible.

Prospective customers of this invention are museums and private collectors (“principal owner”) who wish to get some liquidity from their collectibles, yet still retain physical possession of their collectibles. The principal owner is at liberty to put as few, or as many shares in as they would like, to help them gain their desired amount of revenue.

The process of the invention begins when the principal owner of a collectible decides that they want to fractionalize their collectible and sell fractions or shares to others. The owner contacts an operating company that is authorized to use the system and methods of the invention. The operating company begins by collecting documents from the owner of the collectible from third parties including a recent appraisal that validates the authenticity and value of the collectible (Validation). The principal owner must also provide documentation that the collectible has insurance that meets or exceeds its appraised value.

The principal owner executes a contract with the operating company in which the owner agrees that it will keep the collectible protected, maintain the current condition of the collectible, have the collectible appraised annually, and keep insurance on the collectible at least equal to the most recent appraisal (Execute Contract).

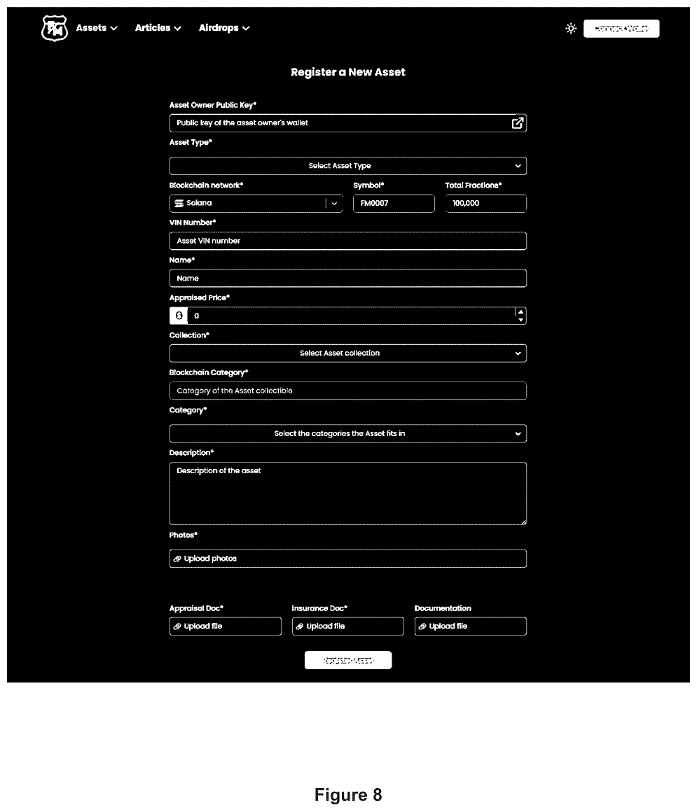

FIG. 8 is an embodiment of a Register a New Asset page that is only available to administrators of the system to register and mint the tokens for a new collectible or asset. The Asset Owner Public Key is a required field where the administrator enters the public blockchain key or wallet address of the principal owner. The Asset Type is a required field where the administrator enters the type of collectible such as car, plane, motorcycle, sculpture, painting, etc. The Blockchain Network is a required field where the administrator enters the blockchain where the tokens will be created such as Ethereum, Polygon, or Solana. The Symbol is an automatically generated field that can be selectively overridden by the administrator that uniquely identifies the collectible. The Total Fractions is an automatically generated field that can be selectively overridden by the administrator. The default value for the Total Fractions field for most assets will be 100,000.

For each type of Asset there will be custom fields that are required for only that type of asset, depending on the system and the assets for which it is configured. For example, for collectible vehicles, a VIN or Vehicle Identification Number is a required field where the administrator enters the serial number from the manufacturer. The Name is a required field where the administrator enters a title for the collectible or asset that will help people to find and identify that item. For example, this could be “1965 Mustang K-Code Convertible” or “1969 Chevelle SS 396 L78.” The Appraised Price is a required field where the administrator enters initial appraised price that the administrator has verified through documentation provided by a third-party appraiser, which is preferably a licensed third-party appraiser. The Collection and Category are required fields where the administrator selects an already registered collection or category which serves like a folder to help categorize the collectible. For example, for a “1965 Mustang K-Code Convertible”, the Collection could be “Ford” and Category could be “Mustang”. The Description is a required field where the administrator describes the collectible, often including the provenance of the asset. Because all of this information is recorded on the blockchain and can later be searched, it is recommended that the principal owner provide as much historical information as possible in the description. Photos, Appraisal Doc, Insurance Doc, and Documentation are all for media documentation that is connected or associated with the collectible or asset.

The above description of FIG. 8 is for a system for fractionalizing tokens in collectable automobiles. It will be appreciated that a particular field, although characterized as a “required field,” might be eliminated in some embodiments or for other types of collectables, provided that security features and advantages of the system are not compromised.

All of these fields are standard, but an unlimited number of additional fields can be configured for every Asset Type. For example if Automobile was selected for Asset Type, fields for Year, Exterior Color, Interior Color, Body Type, Engine, and Transmission would also be displayed and minted on the token.

The operating company then mints a selected number of tokens (such as 100,000) that reflects 100% ownership of the collectible and deposits the tokens in the owner's blockchain wallet (Mint Tokens).

The collectible owner chooses the number of shares that they wish to sell off at any given time in the marketplace. The price of these shares is determined by the owner, although it is recommended initially to be equal to the appraisal price of the collectible divided by the total number of tokens (Offer Tokens).

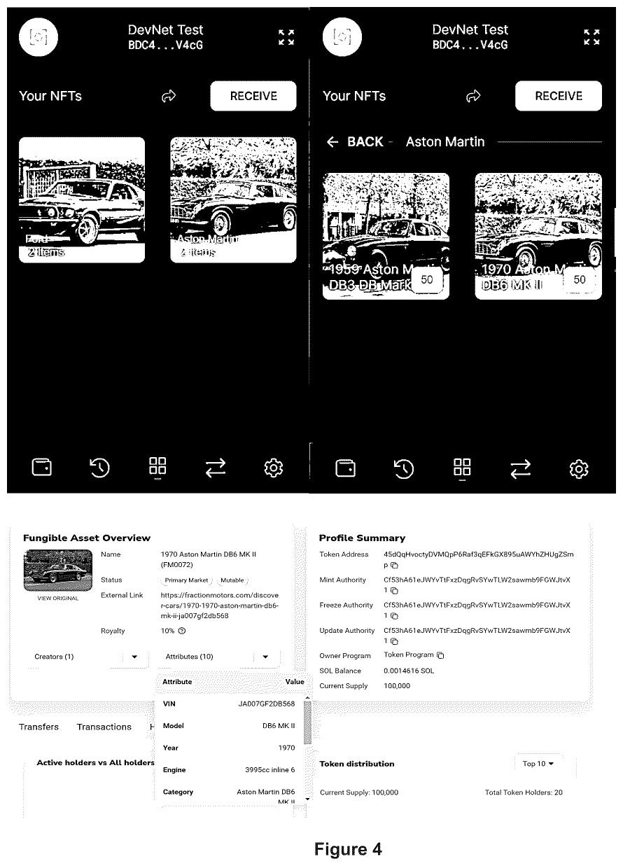

A buyer finds the collectible they want on the website. The buyer connects their digital wallet to the site. A prospective buyer then has the choice of purchasing shares from the initial offering, or the secondary market price. In the case of an initial offering, the buyer selects the number of shares to purchase at the offering price. The buyer then presses “buy” and confirms the purchase of the shares through their digital wallet (Purchase Tokens). On the secondary market, the buyer has the option of being a market maker or a taker in terms of placing their own shares for sale or buying someone else's shares. An offer can be made on the secondary market by anyone with shares they are willing to sell of that asset for their own price. One can also be a market taker on the secondary market by purchasing the orders that have been listed by other market makers. A market taker can choose the number of shares that they are willing to buy at the share price of the secondary market. Once purchased, a buyer will find their tokens organized in their digital wallet, as shown in one embodiment of a digital wallet screen in FIG. 4. These tokens can be sold on the secondary market to other potential buyers who wish to own shares of these collectibles.

In embodiments, buyers will find their tokens arranged in their digital wallets organized in folders by collections, as shown in FIG. 4. For example, the top category or folder might contain Aston Martin and Ford folder because the wallet contains both vehicle makes. The Ford folder might contain a subcategory or folder for Mustang and inside the Mustang folder they might see several different Mustangs of various years in which they hold shares or fractions. The Aston Martin folder might not contain subfolders. When the user clicks on an image of one of the Aston Martin vehicles, they would see all the information about that vehicle stored on the blockchain including images, videos, vehicle identification number, and attributes such as year, make, color, engine size, body type, and transmission type. In addition to these attributes, important documents related to the vehicle will be stored on the blockchain and a historical record of changes to those documents will be recorded on the blockchain. These documents might include annual appraisals, annual insurance renewals, maintenance records, awards, and racing history.

In embodiments, if the principal owner sells all their shares or a predetermined maximum in the contract (such as 51%, 66%, or 80%), the operating company will take title or possession of the collectible on behalf of the other token holders. In embodiments, if the principal owner was a museum, title would be transferred to the operating company but possession would be maintained by the museum.

If the collectible is damaged (Collectible Damaged), the principal owner would collect payment for the damages and the operating company would disperse the pro rata funds to all token holders based on their percent holdings in their wallet (Funds Dispersed).

If the collectible is sold (Collectible Sold), the operating company disperses the pro rata funds to all token holders based on their percent holdings in their wallet (Funds Dispersed). The token will remain on the blockchain, but will be noted or identified as “redeemed.” The new owner of the collectible can choose to continue to keep the collectible on the blockchain and execute a new agreement with the operating company and optionally mint new tokens.

In an embodiment of the invention, the operating company can include the contract that certain decisions relating to the collectible will be voted upon by all the token holders. These decisions might include the decision to sell the collectible when a bona fide offer has been made to the operating company or the principal owner, change of location of the collectible, or whether to restore or disperse insurance funds in the event that the collectible is damaged. Because all the shares can be seen on the blockchain, a notice of a vote can be sent as a special token to those wallets to notify them that a vote is being called. The holder of the token would simply connect their wallet and be notified that there is a vote currently underway for all token holders.

### Inventory Page

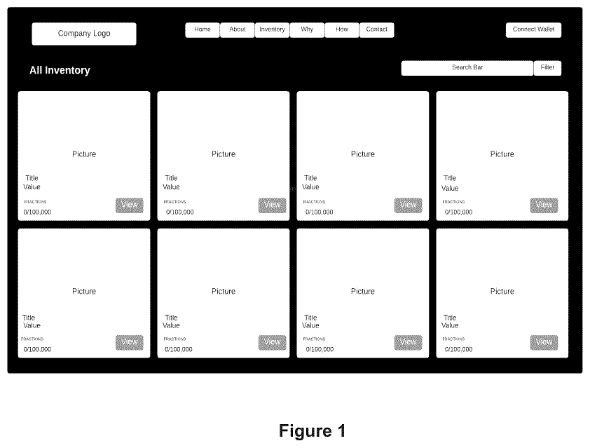

As shown in the embodiment of FIG. 1, when the Inventory page is accessed on the website, the All Inventory page is pulled up, depicting all collectibles placed on the website. The Company Logo is the image that represents the operating company that is holding these collectibles on their website (e.g. “Fraction Motors”), and their logo is represented in the top left corner. In embodiments, if the Company Logo is clicked, then the user is taken back to the homepage of the website. In the central top part of the page are several buttons that one can click to take the user to either the Home page, About page, Inventory page (will refresh the current Inventory page that is depicted here), Why page, How page, or the Contact page. The Connect Wallet button in the top right-hand corner is how a user connects their digital wallet to the company website. This All Inventory page shows every collectible that is listed on the company website that users can browse through or purchase fractions of the listed collectibles. The Search Bar to the right-hand side of the screen can be selected and typed into to find a specified collectible on the website. The Filter button is selected to refine the type of collectibles that are shown on the page. For example, the user can filter the search by specific make, design, model, color, material, etc. A Picture of the collectibles is shown in each square on the Inventory page to visibly show the user what the collectible looks like. The Title is the name of the collectible and how the name appears on the Blockchain. The Value is listed as a number and is underneath the Title. The Value is the Initial Offer Price (which is shown in the following chart once a collectible has been clicked on) of the collectible. Underneath the Value are the Fractions of each of the collectibles which will change depending on the number of fractions that have been purchased.

### Initial Buy Page

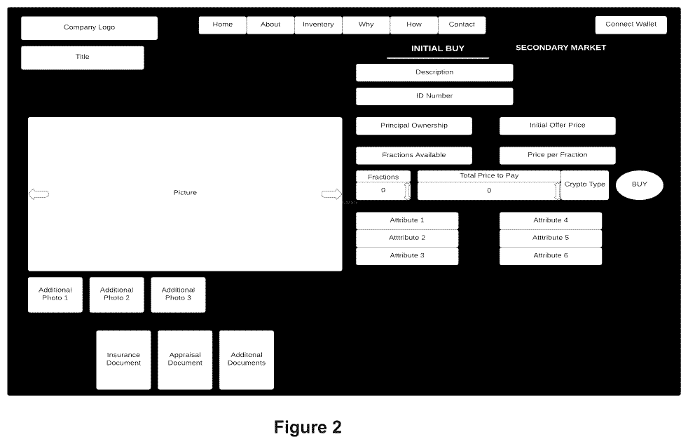

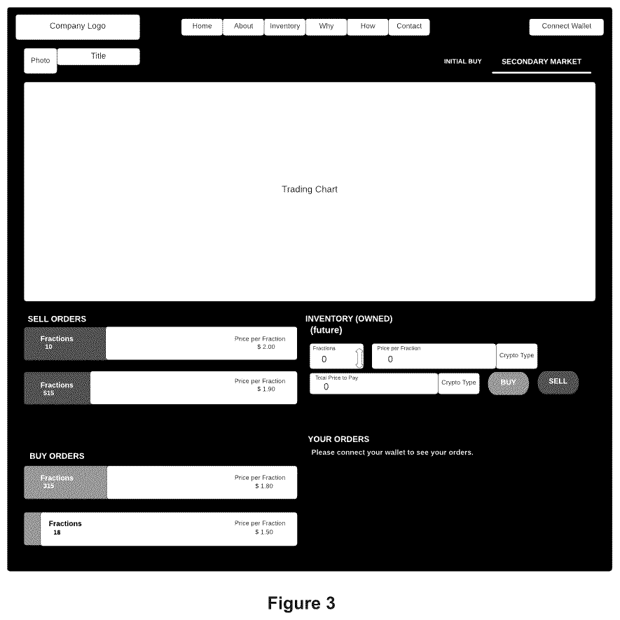

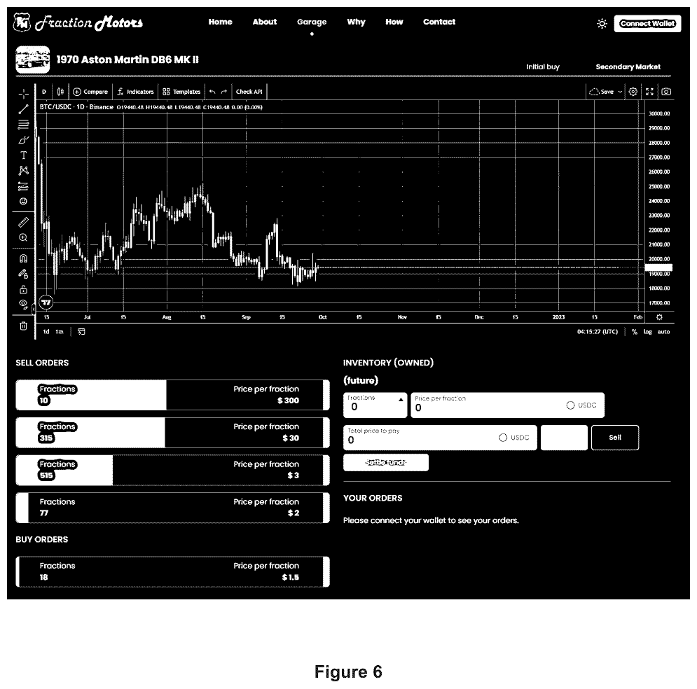

FIG. 2 is an embodiment of an Initial Buy page that is shown when a user of the system has selected a specific collectible from the All Inventory page. The Company Logo shows which website the collectible is placed on and allows access back to the original home page if the logo is clicked. The top central bar allows a user to go to the Home page, About page, Inventory page, Why page, How page, or Contact page. In the top right-hand corner is the Connect Wallet button, which the user clicks to connect their digital wallet to the website to either buy or sell their collectible shares. Underneath the company's logo is the Title of the collectible. The Title is the name of the collectible and how it appears in a user's digital wallet. What will also be shown in a user's digital wallet is the first picture that is shown when any collectible's page is pulled up. The first viewed photo is shown in the picture box, and the photos preceding it are shown in the additional photo section underneath the large picture box. Users can slide through each photo of each collectible by selecting the left and right arrows on the picture box. The documentation for each collectible helps back up the proof of physical evidence of the collectible. Each collectible is required to have an Insurance Document and Appraisal Document. Any additional documentation that has been recorded on the collectible is placed under the Additional Documents section. Underneath the Initial Buy tab is the description of the collectible that describes the history, rarity, and attributes of the collectible. The ID Number shows proof of evidence that connects the digital collectible shown to a physical one. The Principal Ownership lists the number of shares the collectible's owner possesses before they started selling their shares. Fractions Available lists the number of fractions that are available to be purchased on the blockchain. The Initial Offer Price is the initial price at which the owner placed the collectible for sale. The Price Per Fraction is the best price at which buyers can buy the fractions in the market, and in the case of the initial offering it is the initial offer price per token. For example, if the initial offer price is listed at $150,000, then the price per fraction will show that the fractions can be bought at $1.50 because each collectible is divided into 100,000 shares. Underneath the Fractions Available section is the Fractions box, where buyers can place the number of fractions that they are willing to buy of the collectible by either typing the number of the desired number of shares that are hoping to be bought. The Total Price to Pay box is located right next to the fractions bar and is calculated with the number of fractions that are placed in the fractions box multiplied by the price per fraction section. The crypto type is the type of crypto that is being used for payments for each share. The attribute boxes represent the special qualities of each collectible that makes them valuable. For example, a 1969 Mustang Mach 1 could have attributes under this section listed as Year: 1969 Make: Ford Model: Mustang Mach 1 Color: Blue Interior: Black Body Type: Hatchback Engine: 428 Cobra Jet Transmission: 4 Speed Manual. Clicking the Secondary Market tab that is located next to the Initial Buy tab will take the user to the secondary market page, embodiments of which are shown in FIGS. 3 and 6.

### Secondary Market Page

With reference to FIGS. 3 and 6, the Company Logo in the top left corner again serves the same purpose and if clicked will take the user back to the homepage of the website. Underneath the Company Logo is a small Photo of the collectible with its Title next to it. The central bar at the top middle serves the same purpose of being able to take the user to the Home page, About page. Inventory page, Why page, How page, and Contact page. The Connect Wallet button allows the user to connect their digital wallet to the website so that they can purchase or sell shares of collectibles. The Trading Chart depicts a live chart that depicts the buy and sell orders that have gone through for the collectible being shown in the Photo and Title. The Sell Orders and the red boxes underneath it represent the real-time orders in which people are selling their shares of collectibles. For example, if a potential seller had 5 shares of a rare Jamaican pottery bowl that was up on the website and they were to sell their 5 shares for any price, the order would be shown under the sell orders section here. The lower-priced sell orders will be seen at the bottom of the Sell Orders section. Contrary, the higher-priced orders will be shown at the top of the Sell Orders section. The number of shares being sold in an order is shown on the left side of the bar underneath the word Fractions. The price that the seller has listed their shares for is shown on the right side of the bar under the Price per Fraction. Underneath the Sell Orders in red are the Buy Orders in green. Very similar to the Sell Orders and how they are demonstrated, the Buy Orders work in the same way. The Buy Orders are the price at which someone is willing to buy your shares of a collectible. So, for example, if a user were to see a buy order for 5 fractions for $2.00 per share, then the user could click on that buy order to sell their 5 fractions at that specified price. Similarly, the Price per Fraction can be seen on the right side of each Buy Order and is also sorted by price with the most expensive Price per Fraction orders being at the top of the section and the least being at the bottom. The New Order section represents the inventory that you are about to buy at the secondary market value. The Fractions box can be increased or decreased, or a number can be typed in for how many fractions the user wants to purchase or sell on the secondary market of the collectible. The Price per Fraction next to the Fractions box will automatically fill in with the price of what the fractions are selling for on the secondary market. The Total Price to Pay is automatically filled in after selecting the number of fractions a user of the system wants to buy, or by selecting one of the Buy Orders or Sell Orders. Once a user's wallet is connected to the website, the user can see their orders placed underneath the Total Price to Pay section in the section labeled Your Orders. From there, the user can cancel an order by pressing the Cancel Order button or viewing their past orders.

Methods of generating revenue from the methods and systems are also provided. In embodiments, an owner or licensed administrator of the processing system collects a royalty from an asset owner for registering an asset with the processing program. This royalty can be significantly less than conventional auction house or agent fees, such as four, five, six, seven, eight or nine percent of the appraised value of the asset at registration, or the eventual sales price of the asset when sold. Annual fees can also be charged to the asset owners. In other embodiments, an owner or licensed administrator of the processing system collects a transaction fee from buyers upon purchase of tokens. In other embodiments, an owner or licensed administrator of the processing system collects a transaction fee from sellers upon sale of tokens.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A method of administering an online blockchain platform that allows users to purchase and sell tokens stored on a blockchain that are associated with a particular collectible asset, said blockchain providing a shared, immutable ledger that facilitates the process of recording transactions and tracking tokens of collectable assets in a decentralized network, comprising:
providing a processing program for fractionalizing an asset into tokens and for enabling a market for purchase and sale of the tokens, the processing program providing a visual interface for use by a plurality of buyers and sellers for offering to sell and purchase tokens representing fractions of assets;
providing at least one collectable asset for fractionalizing into tokens using the processing program, the at least one collectable asset owned by an asset owner;
registering the at least one collectable asset with the processing program, registering including:
fractionizing a plurality of blockchain tokens reflecting one hundred percent ownership of the collectible asset, the tokens entitling holders of the tokens to rights in a future disposition of the collectible asset, including a proportionate percentage of any future sale or insurance proceeds of the collectible asset.

2. The method of claim 1, wherein providing at least one asset for fractionalizing into tokens comprises:
the asset owner proving title to the asset;
the asset owner providing an appraisal of the asset, the asset obtained from an appraiser; and
the asset owner providing proof of insurance on the asset up to at least the value of the appraisal.

3. The method of claim 2, wherein the appraiser is a licensed appraiser.

4. The method of claim 1, further comprising using the processing program to enable users of the processing program to purchase tokens of the at least one collectable asset from the asset owner in an initial offering and thereby become holders of the tokens, the processing program associating purchased tokens with blockchain wallets of each holder of a token.

5. The method of claim 4, further comprising using the processing program to enable holders of tokens of the at least one collectable asset to offer to sell and to sell tokens to subsequent holders of tokens in a secondary market, the processing program associating purchased tokens with blockchain wallets of each subsequent holder of a token.

6. The method of claim 2, wherein registering a collectable asset further includes using a Register a New Asset page for
recording an Asset Owner Public Key comprising a public blockchain key or wallet address of the asset owner;
recording an Asset Type identifying the type of asset,
recording a Blockchain Network on which the tokens will be created,
generating a Symbol that uniquely identifies the collectible asset,
assigning a Total Fractions figure consisting of the number of tokens for the collectable asset.

7. The method of claim 6, wherein registering a collectable asset further includes using the Register a New Asset page for recording a Vehicle Identification Number.

8. The method of claim 6, wherein registering a collectable asset further includes using the Register a New Asset page for recording an appraised price of the collectable asset.

9. The method of claim 6, wherein registering a collectable asset further includes using the Register a New Asset page for recording a description of the collectable asset.

10. The method of claim 6, wherein registering a collectable asset further includes using the Register a New Asset page to associate media documentation with the assets, such as photos, appraisal documents, and insurance documents.

11. The method of claim 6, wherein a default value for the Total Fractions is 100,000.

12. The method of claim 2, wherein each asset owner maintains possession of their respective collectable asset and is responsible for maintaining the condition of the asset.

13. The method of claim 2, wherein an owner or licensed administrator of the processing system collects a royalty from an asset owner for registering an asset with the processing program.

14. The method of claim 2, wherein an owner or licensed administrator of the processing system collects a transaction fee from buyers upon purchase of tokens.

15. The method of claim 2, wherein an owner or licensed administrator of the processing system collects a transaction fee from sellers upon sale of tokens.

16. The method of claim 7, wherein the at least one asset is a motor vehicle.

17. The method of claim 16, wherein the motor vehicle is an automobile, a truck, a boat or a motorcycle.
